(19) United States
(12) Patent Application Publication
(10) Pub. No.: US 2026/0264003 A1
(43) Pub. Date: Sep. 10, 2026

(54) AIR DRYER

(71) Applicant: Samsung Electronics Co., Ltd., Suwon-si (KR)

(72) Inventors: Seounghwan Hyeon, Suwon-si (KR); Tae-ung Yoon, Suwon-si (KR); Sungmin Jang, Suwon-si (KR); Jongwook Lee, Asan-si (KR); Changseg Lim, Asan-si (KR)

(73) Assignees: Samsung Electronics Co., Ltd., Suwon-si (KR); Eunha Airtechnology Co., Ltd., Asan-si (KR)

(21) Appl. No.: 19/349,925

(22) Filed: Oct. 3, 2025

(30) Foreign Application Priority Data
Mar. 6, 2025 (KR) 10-2025-0029197

(51) Int. Cl. B01D 53/26; B01D 53/04

(52) U.S. Cl. CPC B01D 53/261; B01D 53/0438; B01D 53/0446

(57) ABSTRACT

Provided is an air dryer. The air dryer includes a first tank, and a heater connected to the first tank. The heater includes a housing extending in a first direction and having an internal space including a first guide region and a second guide region, which are spaced apart from one another in the first direction, a first baffle provided in the first guide region, a second baffle provided in the second guide region, and a first flow guide between the first guide region and the second guide region. Each of the first and second guide regions includes a first region and a second region, a portion of the second region of the first guide region is adjacent to the first region of the second guide region in the first direction, and the first flow guide is adjacent to the second region of the first guide region in the first direction.

### CROSS-REFERENCE TO RELATED APPLICATIONS

This present application claims priority to and the benefit under 35 U.S.C. § 119(a)-(d) of Korean Patent Application No. 10-2025-0029197, filed on Mar. 6, 2025, in the Korean Intellectual Property Office, the entire disclosure of which is incorporated herein by reference.

### FIELD

The present disclosure relates to an air dryer. More particularly, the present disclosure relates to an air dryer that improves efficiency of each of a heater and an adsorption to reduce power consumption.

### BACKGROUND

Semiconductor devices may be manufactured by various processes. For example, such a semiconductor device may be manufactured through an etching process, a deposition process, a development process, and a testing process. In some processes of manufacturing the semiconductor device, it may be necessary to introduce gases. For example, a gas may need to be introduced into a chamber in which the semiconductor device is manufactured. Here, the gas supplied to the process of manufacturing the semiconductor device may be required to have low humidity. A process of converting the supplied gas into a dry gas may be required. To dry the gas, a process of allowing the gas to pass through a tank filled with an adsorbent may be required.

### SUMMARY

The present disclosure provides an air dryer that reduces power consumption.

The problems to be solved by the present invention are not limited to the aforementioned technical objects and unmentioned technical objects will be clearly understood by those skilled in the art from the specification and the appended claims.

Embodiments of the disclosed concepts provide an air dryer including: a first tank; and a heater connected to the first tank, wherein the heater includes: a housing extending in a first direction and having an internal space including a first guide region and a second guide region, which are spaced apart from one another in the first direction; a first baffle provided in the first guide region; a second baffle provided in the second guide region; and a first flow guide between the first guide region and the second guide region, wherein each of the first and second guide regions includes a first region and a second region, a portion of the second region of the first guide region is adjacent to the first region of the second guide region in the first direction, and the first flow guide is adjacent to the second region of the first guide region in the first direction.

In embodiments of the disclosed concepts, an air dryer includes: a first tank; a connection line on a side surface of the first tank; and a heater configured to provide a heating gas to the first tank through the connection line, wherein the first tank includes: an adsorption housing filled with adsorbents; and a lower fixing device and an upper fixing device within the adsorption housing, wherein the adsorbents are interposed between the lower fixing device and the upper fixing device, and the connection line includes: a first portion extending to the inside of the adsorption housing by passing through a side surface of the adsorption housing; and a second portion connected to the first portion to pass through the upper fixing device.

In embodiments of the concepts, an air dryer includes: a first tank filled with adsorbents; a connection line connected to the first tank; and a heater configured to a heating gas to the first tank through the connection line, wherein the heater includes: a housing extending in a first direction and having an internal space including a first guide region and a second guide region, which are spaced apart from one another in the first direction; a first baffle provided in the first guide region; a second baffle provided in the second guide region; and a first flow guide between the first guide region and the second guide region, wherein each of the first and second guide regions comprises a first region and a second region, a portion of the second region of the first guide region is adjacent to the first region of the second guide region in the first direction, and the first flow guide is adjacent to the second region of the first guide region in the first direction.

### BRIEF DESCRIPTION OF THE DRAWINGS

The accompanying drawings are included to provide a further understanding of the disclosed concepts, and are incorporated in and constitute a part of this specification. The drawings illustrate embodiments of the disclosed concepts and, together with the description, serve to explain principles of the disclosed concepts. In the drawings:

FIG. 1 is a schematic view of an air dryer according to some embodiments of the disclosed concepts;

FIG. 2 is a cross-sectional view of a heater of FIG. 1;

FIGS. 3 and 4 are cross-sectional views illustrating each of a guide region and a baffle of FIG. 2;

FIGS. 5 to 7 are cross-sectional view illustrating each of the guide region and a flow guide of FIG. 2;

FIG. 8 is a view illustrating a heater according to a comparative example of the disclosed concepts and a traveling direction of a heater airflow inside a heater according to the comparative example;

FIG. 9 is a view illustrating a traveling direction of a heater airflow inside the heater of FIG. 2;

FIG. 10 is a cross-sectional view of the heater of FIG. 1;

FIGS. 11 and 12 are cross-sectional views illustrating each of a guide region, a baffle, and a flow guide of FIG. 10;

FIG. 13 is a plan view of a first tank of FIG. 1;

FIG. 14 is a cross-sectional view taken along line A-A′ of FIG. 13;

FIG. 15 is a plan view illustrating a lower fixing device of the first tank of FIG. 13; and

FIG. 16 is a plan view illustrating an upper fixing device of the first tank of FIG. 13.

### DETAILED DESCRIPTION

Hereinafter, embodiments of the disclosed concepts will be described in detail with reference to the accompanying drawings. Like reference numerals refer to like elements throughout.

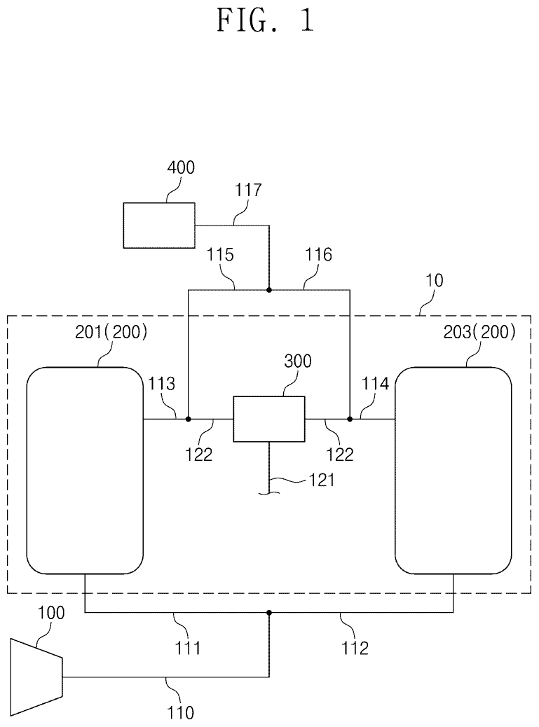

FIG. 1 is a schematic view of an air dryer according to some embodiments of the disclosed concepts.

Referring to FIG. 1, an air dryer 10 may be provided. A gas requiring moisture removal may be provided to the air dryer 10. For example, a compressed gas may be provided to the air dryer 10. Here, the air dryer 10 may perform a function of removing moisture from the compressed gas supplied from a compressor 100. The compressor 100 may be connected to the air dryer 10 via a gas supply line 110. The air compressed by the compressor 100 may be provided to the air dryer 10 through the gas supply line 110.

For example, the air dryer 10 may be an adsorption-type air dryer, but is not limited thereto, and may also include an absorption-type or refrigeration-type air dryer. For example, the air dryer 10 may be a heater purge type, but is not limited thereto. As another example, the air dryer 10 may be a blower non-purge type, and a dual type including the heater 300 may be sufficient.

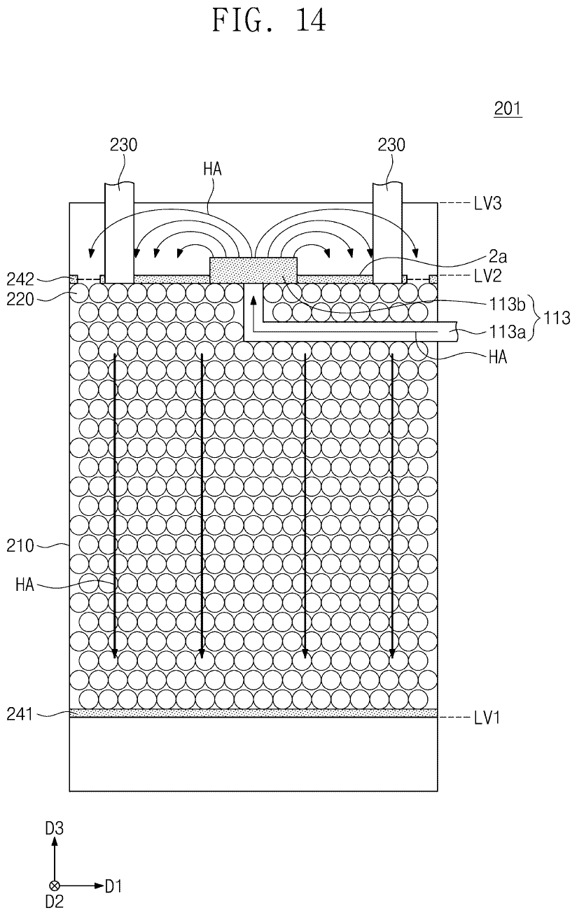

The air dryer 10 may include a tank 200, a heater 300, first to fourth lines 111, 112, 114, and 116, first and second connection lines 113 and 115, and first and second heater lines 121 and 122. The tank 200 may perform a function of removing moisture from a gas supplied to the tank 200. For example, adsorbents (see 220 of FIG. 14) described below may be provided within the tank 200, and the moisture in the gas supplied to the tank 200 may be removed through the adsorbents (see 220 of FIG. 14).

The tank 200 may be provided in plurality. For example, the tank 200 may include a first tank 201 and a second tank 203. The first tank 201 may be connected to the gas supply line 110 through the first line 111. The second tank 203 may be connected to the gas supply line 110 through the second line 112. Thus, the compressed gas may be provided to each of the first tank 201 and the second tank 203.

For example, the compressed gas passing through the gas supply line 110 may be alternately supplied to the first tank 201 and the second tank 203. In other words, when the compressed gas passing through the gas supply line 110 passes through the first line 111 and is supplied to the first tank 201, the compressed gas passing through the gas supply line 110 may not be introduced into the second line 112. Conversely, when the compressed gas passing through the gas supply line 110 passes through the second line 112 and is supplied to the second tank 203, the compressed gas passing through the gas supply line 110 may not be introduced into the first line 111. Although not shown in the drawing, a valve (not shown) may be provided between each of the first and second lines 111 and 112 and the gas supply line 110. The valve may set a path of the compressed gas passing through the first and second lines 111 and 112.

The first connection line 113 may be connected to the first tank 201. The compressed gas supplied to the first tank 201 may be provided to the first connection line 113 in a state in which moisture is removed. The second connection line 114 may be connected to the second tank 203. The compressed gas supplied to the second tank 203 may be provided to the second connection line 114 in a state in which moisture is removed.

The heater 300 may perform a function of heating the gas supplied from the first heater line 121. The second heater lines 122 may be connected to the heater 300. One of the second heater lines 122 may be connected to the heater 300 and the first connection line 113. Thus, the gas heated inside the heater 300 may be transferred to the inside of the first tank 201 through the second heater line 122 and the first connection line 113. Another one of the second heater lines 122 may be connected to the heater 300 and the second connection line 114. Thus, the gas heated inside the heater 300 may be delivered to the inside of the first tank 201 through the second heater line 122 and the second connection line 114.

The third line 115 may be connected to the first connection line 113. The fourth line 116 may be connected to the second connection line 114. The third and fourth lines 115 and 116 may be connected to a discharge line 117. The gas from which the moisture is removed and which is discharged from the tank 200 may be provided to a Fab 400 through the third and fourth lines 115 and 116 and the discharge line 117.

A valve (not shown) may be provided between the first connection line 113 and the second heater line 122, and between the first connection line 113 and the third line 115. Thus, during the moisture removal process, the valve between the first connection line 113 and the second heater line 122 may be closed, and the valve between the first connection line 113 and the third line 115 may be opened. As a result, the gas from which the moisture is removed and which is discharged from the first tank 201 may be provided within the Fab 400.

Conversely, during a regeneration process, the valve between the first connection line 113 and the second heater line 122 may be opened, and the valve between the first connection line 113 and the third line 115 may be closed. As a result, the gas heated from the heater 300 may be provided into the first tank 201, and moisture in the adsorbents (see 220 in FIG. 14) obtained from the compressed gas may be removed due to the moisture removal process.

A valve (not shown) may be provided between the second connection line 114 and the second heater line 122, and between the second connection line 114 and the fourth line 116. Thus, during the moisture removal process, the valve between the second connection line 114 and the second heater line 122 may be closed, and the valve between the second connection line 114 and the fourth line 116 may be opened. As a result, the gas from which moisture has been removed and which is discharged from the second tank 203 may be provided into the Fab 400.

Conversely, during the regeneration process, the valve between the second connection line 114 and the second heater line 122 may be opened, and the valve between the second connection line 114 and the fourth line 116 may be closed. As a result, the gas heated from the heater 300 may be provided into the second tank 203, and the moisture in the adsorbents (see 220 in FIG. 14) obtained from the compressed gas may be removed due to the moisture removal process.

The moisture removal process and the regeneration process of the tank 200 may be performed independently of one another. For example, when the moisture removal process is performed in the first tank 201, the regeneration process may not be performed in the first tank 201. For example, when the moisture removal process is performed in the first tank 201, the regeneration process may be performed in the second tank 203. Similarly, when the moisture removal process is performed in the second tank 203, the regeneration process may not be performed in the second tank 203. For example, when the moisture removal process is performed in the second tank 203, the regeneration process may also be performed in the first tank 201.

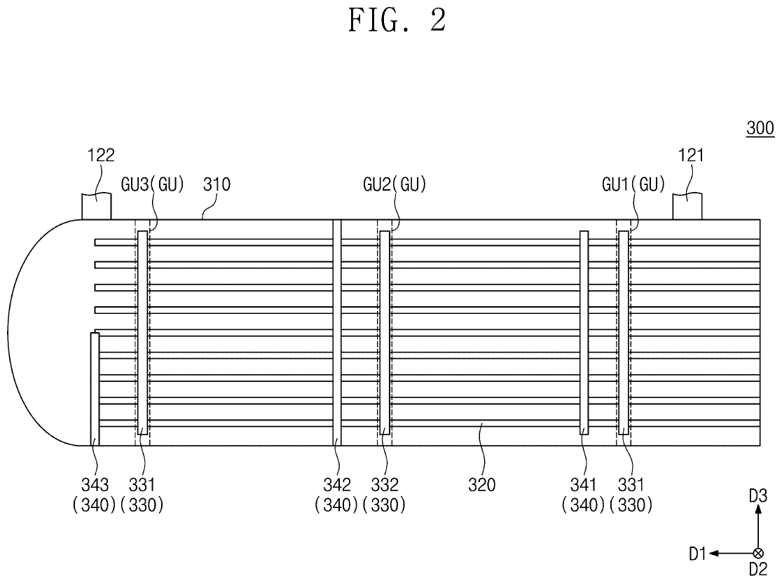

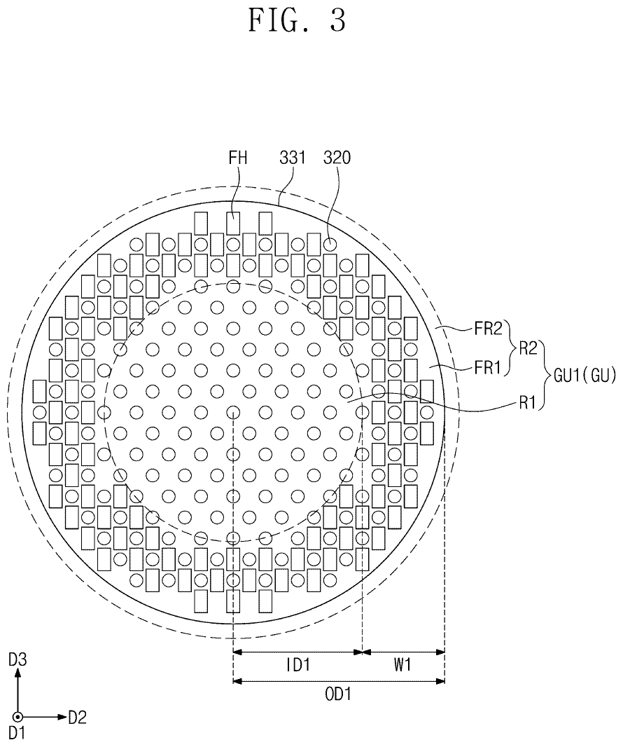

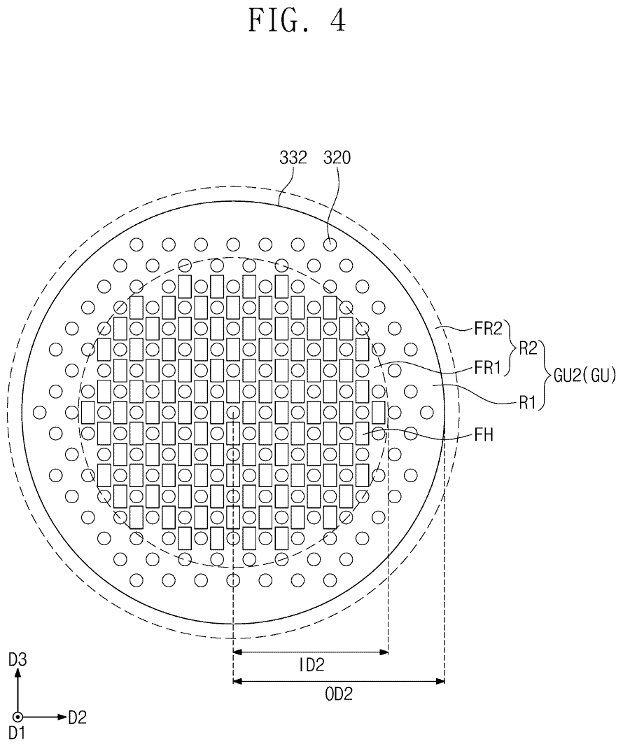

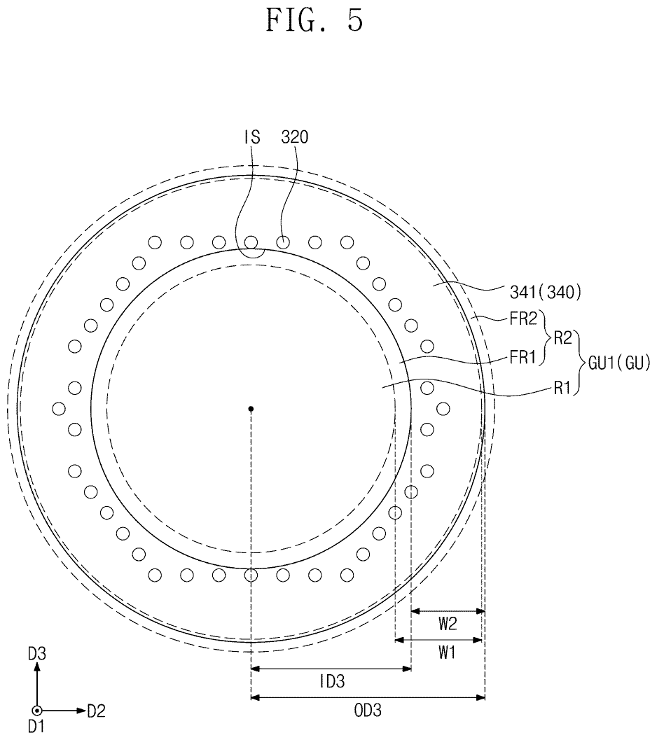

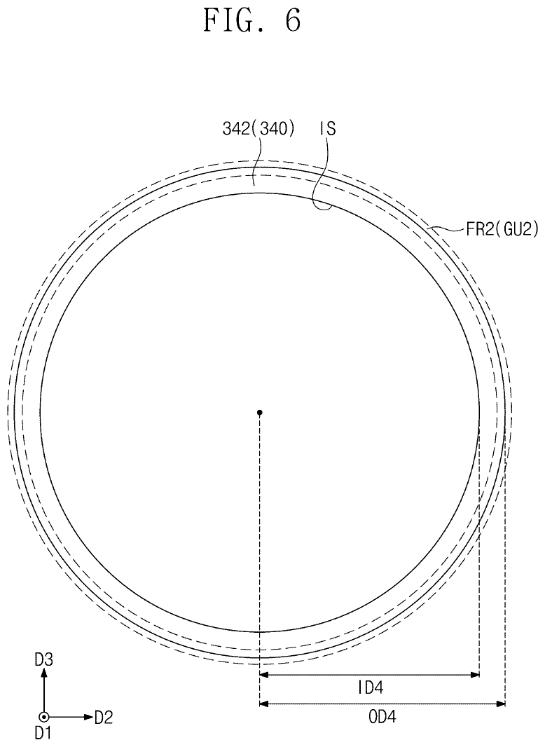

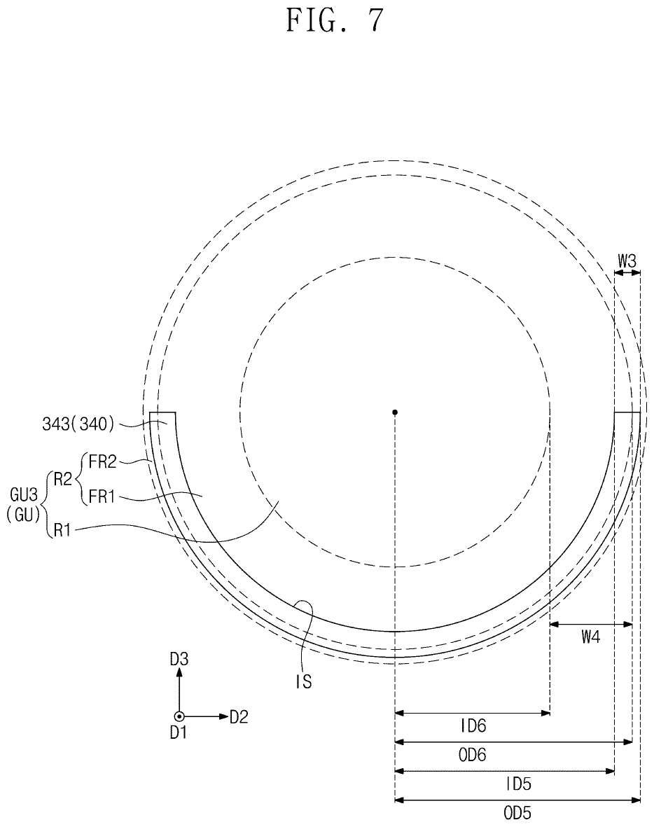

FIG. 2 is a cross-sectional view of the heater 300 of FIG. 1. FIGS. 3 and 4 are cross-sectional views illustrating each of a guide region GU and a baffle 330 of FIG. 2. FIGS. 5 to 7 are cross-sectional view illustrating each of the guide region GU and a flow guide 340 of FIG. 2.

The heater 300 may include a housing 310, a heating wire 320, a baffle 330, a flow guide 340, a first heater line 121 that functions as an inlet, through which a gas is introduced into the housing 310, and a second heater line 122 that functions as an outlet, through which a heating gas is discharged from the housing 310.

The housing 310 may have a shape in which a space is defined therein and which extends along a first direction D1. The first direction D1 may be a direction parallel to a bottom surface on which the air dryer 10 is installed. The second direction D2 may be a direction that is parallel to the bottom surface and orthogonal to the first direction D1. The third direction D3 may be a direction perpendicular to the bottom surface. As another example, the housing 310 may have a shape extending along a third direction D3.

The housing 310 may include the guide region GU in an internal space thereof. In this specification, the guide region GU may be defined as a region that guides a flow direction of a gas when the gas introduced through the first heater line 121 proceeds in the first direction D1 within the housing 310.

The guide region GU may include a first region R1 and a second region R2. The first region R1 of the guide region GU may be a closed region. In other words, the first region R1 of the guide region GU may be a portion of the guide region GU through which the gas within the housing 310 does not pass. The second region R2 of the guide region GU may be a flow region. In other words, the second region R2 of the guide region GU may be the other portion of the guide region GU, through which the gas within the housing 310 passes. As described above, the guide region GU may control a flow path of the gas within the housing 310 by inducing the gas within the housing 310 to pass through the second region R2 of the guide region GU without passing through the first region R1 of the guide region GU. In addition, the second region R2 of the guide region GU may include a first flow region FR1 and a second flow region FR2.

The baffle 330 may be provided within the housing 310. First, the number of guide regions GU may vary depending on the number of baffles 330. The baffle 330 may be provided in plurality. For example, the baffle 330 may include first and second baffles 331 and 332 spaced apart from one another in the first direction D1 within the housing 310. The second baffle 332 may be interposed between a pair of first baffles 331. Depending on the number of the baffles 330, the guide region GU may include a first guide region GU1, a second guide region GU2, and a third guide region GU3, which are provided sequentially along the first direction D1. In the first baffles 331, the first baffle 331 adjacent to the first heater line 121 may be provided within the first guide region GU1. The second baffle 332 may be provided within the second guide region GU2. In the first baffles 331, the first baffle 331 adjacent to the second heater line 122 may be provided within the third guide region GU3.

Next, a position of each of the first region R1 and the second region R2 of the guide region GU may vary depending on the shape of the baffles 330. For example, each of the baffles 330 may have a disc shape. The baffles 330 may include flow holes FH. The flow holes FH may pass through the baffle 330. Thus, the gas inside the housing 310 may pass through the flow holes FH.

The first and second baffles 331 and 332 may include a first region, in which the flow holes FH through which the gas within the housing 310 passes are provided, and a second region in which no flow holes FH are provided. Since the second regions of each of the first and second baffles 331 and 332 do not include the flow holes FH through which the gas within the housing 310 passes, the gas within the housing 310 may not pass through the second region of each of the first and second baffles 331 and 332. The first region of the first baffle 331 may surround the second region of the first baffle 331. The second region of the second baffle 332 may surround the first region of the second baffle 332. The first region of each of the first and second baffles 331 and 332 may be defined as the first flow region FR1 of the second region R2 of the guide region GU. The second region of each of the first and second baffles 331 and 332 may be defined as the first region R1 of the guide region GU. According to the above-described definition, the first flow region FR1 of the second region R2 of the first guide region GU1 may surround the first region R1 of the first guide region GU1. The first region R1 of the second guide region GU2 may surround the first flow region FR1 of the second region R2 of the second guide region GU2. The first flow region FR1 of the second region R2 of the third guide region GU3 may surround the first region R1 of the third guide region GU3. For example, from the point of view in cross-section, each of the first flow region FR1 of the second region R2 of each of the first guide region GU1 and the third guide region GU3 and the first region R1 of the second guide region GU2 may have a virtual shape such as a circular ring. For example, from the point of view in cross-section, each of the first flow regions FR1 of the first region R1 of the first guide region GU1 and the third guide region GU3 and the second region R2 of the second guide region GU2 may have a virtual shape like a circular plate.

The first flow region FR1 of the second region R2 of each of the first guide region GU1 and the third guide region GU3 may be adjacent to the first region R1 of the second guide region GU2 in the first direction D1. The first flow region FR1 of the second region R2 of the second guide region GU2 may be adjacent to the first region R1 of each of the first guide region GU1 and the third guide region GU3 in the first direction D1. The first region R1 of each of the first guide region GU1 and the third guide region GU3 may not be adjacent to the first region R1 of the second guide region GU2 in the first direction D1.

In addition, outer diameters OD1 and OD2 of the first and second baffles 331 and 332 may be less than an inner diameter of the housing 310. Thus, the first and second baffles 331 and 332 and an inner wall of the housing 310 may be spaced apart from one another, and the gas inside the housing 310 may pass between the first and second baffles 331 and 332 and the inner wall of the housing 310. Thus, in this specification, the region between the baffles 330 and the inner wall of the housing 310 in the guide region GU may be defined as the second flow region FR2 of the second region R2 of the guide region GU. The first and second flow regions FR1 and FR2 of each of the first and third guide regions GU1 and GU3 may surround the first region R1 of each of the first and third guide regions GU1 and GU3. The first region R1 of the second guide region GU2 may be interposed between the first and second flow regions FR1 and FR2 of the second guide region GU2.

A heating wire 320 may be provided within the housing 310. The heating wire 320 may be provided in plurality. The heating wires 320 may extend along the first direction D1 within the housing 310 and pass through the baffles 330. Since the heating wires 320 pass through the baffles 330, the baffles 330 may be fixed within the housing 310. The heating wires 320 may allow a temperature of the gas introduced into the housing 310 to increase.

The flow guide 340 may be disposed within the housing 310. Particularly, the flow guide 340 may be disposed adjacent to the guide region GU and may change a traveling direction of the gas passing through the guide region GU. The flow guides 340 may be provided in plurality. For example, the flow guide 340 may include a first flow guide 341 between the first guide region GU1 and the second guide region GU2, a second flow guide 342 between the second guide region GU2 and the third guide region GU3, and a third flow guide 343 spaced apart from the second flow guide 342 in the first direction D1 with the third guide region GU3 therebetween.

The first flow guide 341 may be disposed adjacent to the first guide region GU1. In other words, in the first direction D1, a distance between the first flow guide 341 and the first guide region GU1 may be less than a distance between the first flow guide 341 and the second guide region GU2. For example, a center of the first guide region GU1 and a center of the first flow guide 341 may be aligned in the first direction D1.

The first flow guide 341 may have a shape of a donut-shaped circular ring. The first flow guide 341 may be adjacent to the first flow region FR1 of the second region R2 of the first guide region GU1 in the first direction D1. The first flow guide 341 may not be adjacent to the first region R1 of the first guide region GU1 in the first direction D1. The first flow guide 341 may be adjacent to the first region R1 of the second guide region GU1 in the first direction D1. When the gas passing through the first flow region FR1 of the second region R2 of the first guide region GU1 collides with the first flow guide 341, the traveling direction of the gas may be changed.

An inner diameter ID3 of the first flow guide 341 may be greater than an inner diameter ID1 of the first flow region FR1 of the second region R2 of the first guide region GU1. In the second direction D2, a width W2 of the first flow guide 341 may be less than a width W1 of the first flow region FR1 of the second region R2 of the first guide region GU1. Thus, the first flow guide 341 may not completely overlap the first flow region FR1 of the second region R2 of the first guide region GU1 in the first direction D1. As a result, the first flow guide 341 may change only the traveling direction of the gas without restricting the traveling of the gas. The inner diameter ID3 of the first flow guide 341 may refer to a distance between the center of the first flow guide 341 and an inner surface IS.

For example, an outer diameter OD3 of the first flow guide 341 may be substantially equal to or greater than an outer diameter OD1 of the first flow region FR1 of the second region R2 of the first guide region GU1. However, the outer diameter OD3 of the first flow guide 341 may be less than the inner diameter of the housing 310. Although not shown in the drawing, as another example, the outer diameter OD3 of the first flow guide 341 may be the same as the inner diameter of the housing 310.

The second flow guide 342 may be disposed adjacent to the second guide region GU2. In other words, in the first direction D1, a distance between the second flow guide 342 and the second guide region GU2 may be less than a distance between the second flow guide 342 and the third guide region GU3. For example, a center of the second guide region GU2 and a center of the second flow guide 342 may be aligned in the first direction D1.

The second flow guide 342 may have the shape of a donut-shaped circular ring. The second flow guide 342 may be adjacent to the first region R1 of the second guide region GU2 and the second flow region FR2 of the second region R2 in the first direction D1. The second flow guide 342 may not be adjacent to the first flow region FR1 of the second region R2 of the second guide region GU2 in the first direction D1.

An inner diameter ID4 of the second flow guide 342 may be greater than an inner diameter ID2 of the first region R1 of the second guide region GU2. The inner diameter ID4 of the second flow guide 342 may refer to a distance between the center of the second flow guide 342 and the inner surface IS.

An outer diameter OD4 of the second flow guide 342 may be greater than the outer diameter OD2 of the first region R1 of the second guide region GU2 (i.e., the outer diameter of the second baffle 332). For example, the outer diameter OD4 of the second flow guide 342 may be less than the inner diameter of the housing 310, but is not limited thereto. Although not shown in the drawing, as another example, the outer diameter OD4 of the second flow guide 342 may be the same as the inner diameter of the housing 310. For example, the distance between the second flow guide 342 and the inner wall of the housing 310 may be about 1 mm or more and about 5 mm or less.

Due to the above-described characteristics of the second flow guide 342, the traveling direction of the gas passing through the second flow region FR2 of the second region R2 of the second guide region GU2 may be changed by colliding with the second flow guide 342.

The third flow guide 343 may be disposed adjacent to the third guide region GU3. For example, a center of the third guide region GU3 and a center of the third flow guide 343 may be aligned in the first direction D1.

The third flow guide 343 may have a shape of a semicircular ring. The third flow guide 343 may be disposed at a lower side of the housing 310, which is opposite the second heater line 122. The third flow guide 343 may be adjacent to the first flow region FR1 and the second flow region FR2 of the second region R2 of the third guide region GU3 in the first direction D1. The third flow guide 343 may not be adjacent to the first region R1 of the third guide region GU3 in the first direction D1. The traveling direction of the gas passing through the first flow region FR1 and the second flow region FR2 of the second region R2 of the third guide region GU3 may be changed by colliding with the third flow guide 343.

An inner diameter ID5 of the third flow guide 343 may be greater than an inner diameter ID6 of the first flow region FR1 of the second region R2 of the third guide region GU3. In the second direction D2, a width W3 of the third flow guide 343 may be less than a width W4 of the first flow region FR1 of the second region R2 of the third guide region GU3. Thus, the third flow guide 343 may not completely overlap the first flow region FR1 of the second region R2 of the third guide region GU3 in the first direction D1. As a result, the third flow guide 343 may only change the traveling direction of the gas without restricting the traveling of the gas. The inner diameter ID5 of the third flow guide 343 may refer to a distance between the center of the third flow guide 343 and the inner surface IS.

For example, an outer diameter OD5 of the third flow guide 343 may be greater than an outer diameter OD6 of the first flow region FR1 of the second region R2 of the third guide region GU3 (i.e., the outer diameter of the first baffle 331). For example, the outer diameter OD5 of the third flow guide 343 may be less than the inner diameter of the housing 310, but is not limited thereto. Although not shown in the drawing, as another example, the outer diameter OD5 of the third flow guide 343 may be the same as the inner diameter of the housing 310. For example, the distance between the third flow guide 343 and the inner wall of the housing 310 may be about 1 mm or more and about 5 mm or less. Due to the above-described characteristics of the third flow guide 343, the traveling direction of the gas passing through the second flow region FR2 of the second region R2 of the third guide region GU3 may be changed by colliding with the third flow guide 343.

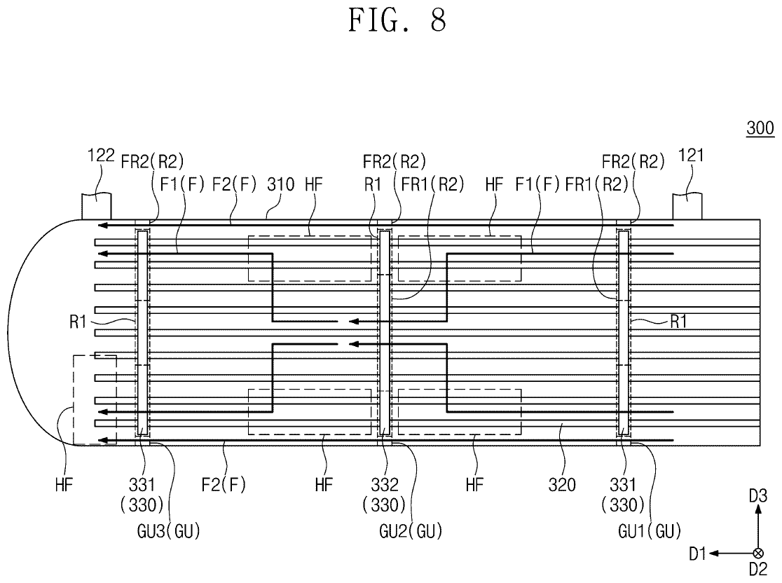

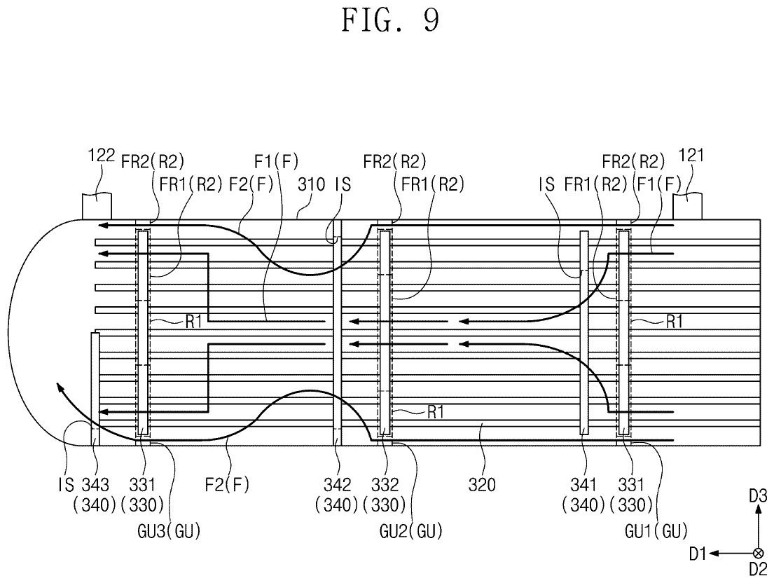

FIG. 8 is a view illustrating a heater 300 according to a comparative example of the disclosed concepts and a traveling direction of a heater airflow F inside a heater 300 according to the comparative example. FIG. 9 is a view illustrating a direction of propagation of a heater airflow inside the heater of FIG. 2.

First, referring to FIG. 8, a heater 300′ of FIG. 8 may correspond to a comparative example of the heater 300 according to some embodiments of the disclosed concepts. The heater 300′ of FIG. 8, unlike the heater 300 of the disclosed concepts, may not include the flow guides 340.

A gas introduced into the housing 310 from the first heater line 121 may follow a traveling direction of a heater airflow F. The heater airflow F may include a first heater airflow F1 and a second heater airflow F2. In the gas introduced into the housing 310, a gas passing through the first flow region FR1 of the guide region GU may follow a traveling direction of the first heater airflow F1. In the gas introduced into the housing 310, a gas passing through the second flow region FR2 of the guide region GU may follow a traveling direction of the second heater airflow F2.

As the gas introduced into the housing 310 passes through different types of baffles 330, the gas may flow along a cross-current flow. That is, the first heater airflow F1 may flow along the cross-current flow. Specifically, when the gas passes through the first baffle 331 within the first guide region GU1, the first heater airflow F1 may have a flow form that diverges from a center of the internal space of the housing 310 to the outer portion. When the gas passes through the second baffle 332 within the second guide region GU2, the first heater airflow F1 may have a flow form that converges from the outer portion of the inner space of the housing 310 to the center. When the gas passes through the first baffle 331 within the third guide region GU3, the first heater airflow F1 may have a flow form that diverges from the center of the internal space of the housing 310 to the outer portion.

A turbulent flow of this first heater airflow F1 may allow a thermal conductivity coefficient of the gas within the housing 310 to increase. In addition, due to the turbulent flow of the first heater airflow F1, it takes a long time for the gas to move from the first heater line 121 to the second heater line 122, and thus, a heat transfer time taken to transfer heat to the gas through the heating wire 320 may increase. As a result, the temperature rise of the gas passing through the housing 310 may increase. In other words, a difference between the temperature of the gas introduced from the first heater line 121 and the temperature of the gas discharged to the second heater line 122 may increase.

However, heat stagnation regions HF of the gas within the housing 310 may be generated by the turbulent motion of the first heater airflow F1. Specifically, the first heater airflow F1 passing through the first flow region FR1 of the first guide region GU1 may collide with the first region R1 of the second guide region GU2 (i.e., the second region of the second baffle 332). Thus, a portion of the first heater airflow F1 may remain between the first flow region FR1 of the first guide region GU1 and the first region R1 of the second guide region GU2. As a result, the heat stagnation regions HF may be generated between the first flow region FR1 of the first guide region GU1 and the first region R1 of the second guide region GU2.

In addition, the first heater airflow F1 passing through the first flow region FR1 of the second guide region GU2 may diverge from the center of the housing 310 to the outer portion to pass through the first flow region FR1 of the third guide region GU3. Here, a portion of the first heater airflow F1 may remain between the second guide region GU2 and the third guide region GU3, and thus, the heat stagnation regions HF may be generated between the second guide region GU2 and the third guide region GU3.

In addition, a portion of the second heater airflow F1 passing through the second flow region FR2 of the second guide region GU2 may remain between the second guide region GU2 and the third guide region GU3, and thus, the heat stagnation regions HF may be generated between the second guide region GU2 and the third guide region GU3.

Due to a fast flow rate of each of the first heater airflow F1 passing through a lower side of the first flow region FR1 of the third guide region GU3 and the second heater airflow F2 passing through a lower side of the second flow region FR2 of the third guide region GU3, the first heater airflow F1 and the second heater airflow F2 may not proceed toward an outlet portion of the housing 310, but may proceed toward the inner wall of the housing 310. Thus, the heat stagnation region HF may be generated by a portion of each of the first heater airflow F1 and the second heater airflow F2, which remain in a region adjacent to the lower side of the third guide region GU3.

Since the heat stagnation regions HF is generated, a portion of the first heater airflow F1 may not be transferred to the outlet portion of the housing 310. In other words, heat transfer up to the outlet portion of the housing 310 may not be sufficient. Thus, the temperature at the outlet portion of the housing 310 may be lower than when there is no heat stagnation region HF. As a result, to adjust the temperature of the outlet portion of the housing 310 to a target temperature, a higher temperature has to be applied to the heating wire 320. In this case, power consumption for driving the heater 300′ may increase.

In addition, since the higher temperature is applied to the heating wire 320, the heating wire 320 may be carbonized. As a result, as a replacement cycle of the heating wire 320 becomes shorter, productivity due to the driving of the heater 300′ may decrease.

In addition to the heat stagnation regions HF, the temperature at the outlet portion of the housing 310 may be lowered due to insufficient heating of the second heater airflow F2. Specifically, since the baffles 330 and the inner wall of the housing 310 are spaced apart from one another, the second heater airflow F2 may proceed to the space between the baffles 330 and the inner wall of the housing 310 (i.e., to the second flow region FR2 of the guide region GU). Thus, unlike the first heater airflow F1 having the turbulent flow, the second heater airflow F2 may have a linear flow. As a result, the heat transfer time for transferring the heat to the gas through the heating wire 320 may be shortened, and the temperature of the outlet portion of the housing 310 may be lowered.

To solve the limitations described above, referring to FIG. 9, the heater 300 of the disclosed concepts may include the flow guides 340 described with reference to FIGS. 2, 5, 6, and 7.

First, a first flow guide 341 may be provided between the first guide region GUI and the second guide region GU2. The first flow guide 341 may change the flow of the first heater airflow F1 into a flow that converges from the outer portion of the housing 310 to the center before the first heater airflow F1 passes through the second guide region GU2. Thus, an amount of first heater airflow F1 colliding with the first region R1 of the second guide region GU2 may be reduced. As a result, an amount of first heater airflow F1 remaining between the first guide region GU1 and the second guide region GU2 may be reduced, and the heat stagnation regions HF of FIG. 8 may be not generated or generated less frequently between the first guide region GU1 and the second guide region GU2. Thus, since the heat transfer is sufficiently achieved to the outlet portion of the housing 310, the temperature of the outlet portion of the housing 310 may increase.

Next, a second flow guide 342 may be provided between the second guide region GU2 and the third guide region GU3. The second flow guide 342 may control the flow direction of the first and second heater airflows F1 and F2 passing through the second guide region GU2, so that the heat stagnation regions HF of FIG. 8 is not generated or is generated less frequently between the second guide region GU2 and the third guide region GU3. Thus, since the heat transfer is sufficiently achieved to the outlet portion of the housing 310, the temperature of the outlet portion of the housing 310 may increase.

In addition, the second flow guide 342 may restrict the traveling of the second heater airflow F2 that flows linearly. Thus, the second heater airflow F2 flowing linearly may pass through the second flow guide 342 and move from the outer portion of the housing 310 toward the center. As a result, the heat transfer time taken to transfer the heat to the second heater airflow F2 through the heating wire 320 may increase. Thus, as the temperature of the second heater airflow F2 increases, the temperature of the outlet portion of the housing 310 may increase.

The third flow guide 342 may be disposed adjacent to the third guide region GU3. The third flow guide 343 may control the flow direction of the first and second heater airflows F1 and F2 passing through the lower side of the third guide region GU3. Specifically, the third flow guide 343 may guide the first and second heater airflows F1 and F2 passing through the lower side of the third guide region GU3 to proceed toward the second heater line 122. Thus, in the region adjacent to the third guide region GU3, the heat stagnation region HF of FIG. 8 may not be generated or may be generated less frequently. Thus, since the heat transfer is sufficiently achieved to the outlet portion of the housing 310, the temperature of the outlet portion of the housing 310 may increase.

As described above, the flow guides 340 may be provided, and thus, the temperature of the outlet portion of the housing 310 may increase. As the temperature of the outlet portion of the housing 310 increases, the power consumption of the heater 300 to adjust the temperature of the outlet portion of the housing 310 to the target temperature may be reduced. Thus, the power consumption of the air dryer (see 10 in FIG. 1) may be reduced.

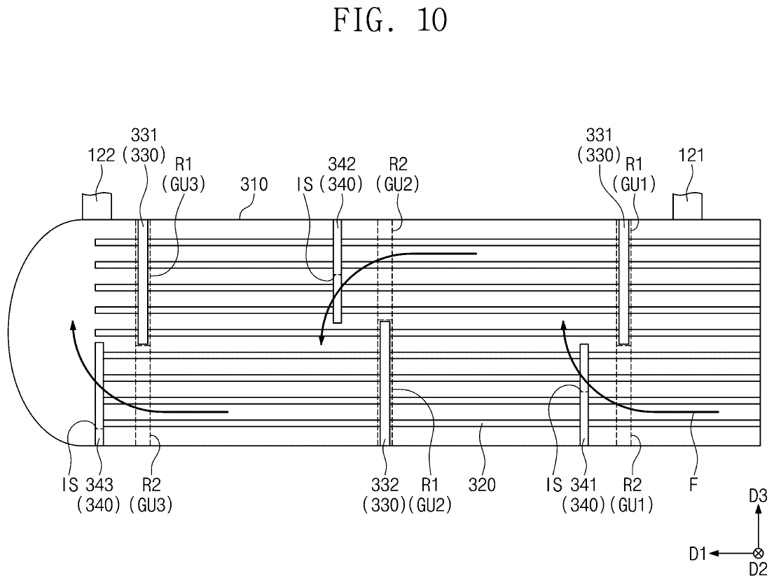

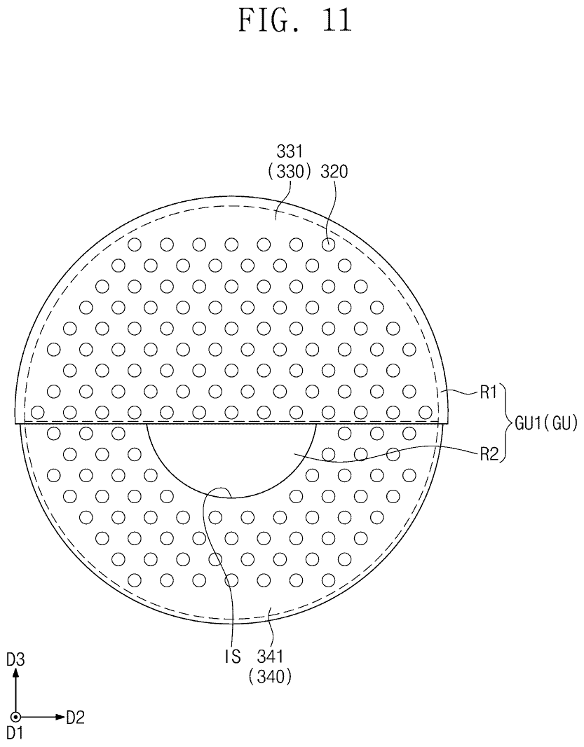

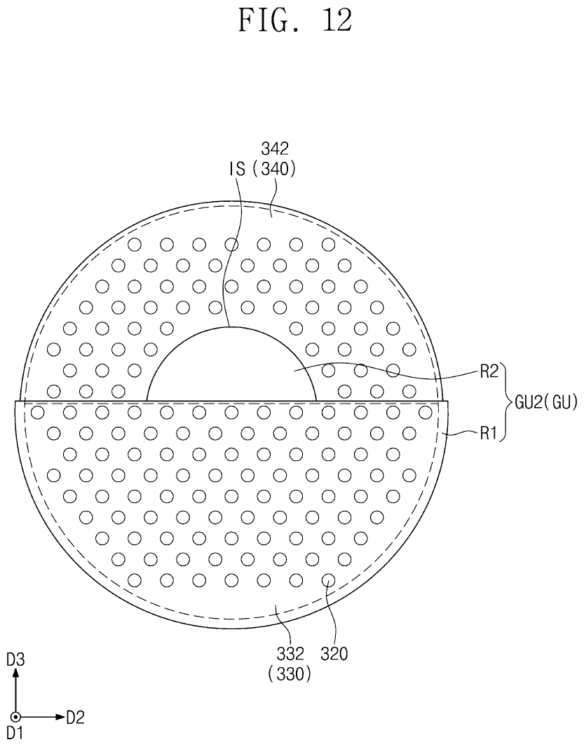

FIG. 10 is a cross-sectional view of the heater 300 of FIG. 1. FIGS. 11 and 12 are cross-sectional views illustrating each of the guide region, the baffle, and the flow guide of FIG. 10.

Referring to FIGS. 10, 11 and 12, shapes of the baffles 330 of FIGS. 10 to 12 may be different from those described with reference to FIGS. 2 to 4. Thus, the shapes of the guide regions GU and the flow guides 340 of FIGS. 10 to 12 may also be different from those described with reference to FIGS. 2 to 7.

Each of the baffles 330 may have a semicircular plate shape in cross-section. The baffles 330 may not include the flow holes FH described with reference to FIGS. 3 and 4. Alternately, since each of the baffles 330 has a semi-circular shape, the gas inside the housing 310 may pass through a region, in which the baffles 330 are not provided, in the guide regions GU. In summary, the first region R1 of each of the guide regions GU may be a portion of the guide region GU in which the baffle 330 is provided. The second region R2 of each of the guide regions GU may be the other portion of the guide region GU in which the baffle 330 is not provided.

The first baffles 331 and the second baffles 332 may be arranged alternately along the first direction D1. The first baffles 331 may be disposed at an upper portion of the inside of the housing 310, and the second baffles 332 may be disposed at a lower portion of the inside of the housing 310. Thus, the heater airflow F may have a turbulent flow.

The flow guides 340 may have a shape of a semicircular ring in cross-section. The first flow guide 341 may not be adjacent to the first region R1 of the first guide region GU1 (i.e., the first baffle 331) in the first direction D1 and may be adjacent to the second region R2 of the first guide region GU1 in the first direction D1. The second flow guide 342 may not be adjacent to the first region R1 of the second guide region GU2 (i.e., the second baffle 332) in the first direction D1 and may be adjacent to the second region R2 of the second guide region GU2 in the first direction D1. The third flow guide 343 may not be adjacent to the first region R1 of the third guide region GU3 (i.e., the first baffle 331) in the first direction D1 and may be adjacent to the second region R2 of the third guide region GU3 in the first direction D1.

Due to the arrangement and shape of the above-described flow guides 340, the heat stagnation region HF described with reference to FIG. 8 may not be generated or may be generated less frequently between the first guide region GU1 and the second guide region GU2, between the second guide region GU2 and the third guide region GU3, and in a region adjacent to the lower portion of the third guide region GU3.

Specifically, the first flow guide 341 may guide the heater airflow F passing through the first guide region GU1 to proceed toward the upper portion of the housing 310. Thus, the heater airflow F may pass more easily through the second region R2 of the second guide region GU2. As a result, the heat stagnation region HF described with reference to FIG. 8 may not be generated or may be generated less frequently between the first guide region GU1 and the second guide region GU2.

The second flow guide 342 may guide the heater airflow F passing through the second guide region GU2 to proceed toward the lower portion of the housing 310. Thus, the heater airflow F may pass more easily through the second region R2 of the third guide region GU3. As a result, the heat stagnation region HF described with reference to FIG. 8 may not be generated or may be generated less frequently between the second guide region GU2 and the third guide region GU3.

The third flow guide 343 may guide the heater airflow F passing through the third guide region GU3 to proceed toward the upper portion of the housing 310. Thus, the heater airflow F may proceed toward the second heater line 122 without stagnating at the lower portion of the housing 310. As a result, the heat stagnation region HF described with reference to FIG. 8 may not be generated or may be generated less frequently in a region adjacent to the lower portion of the third guide region GU3.

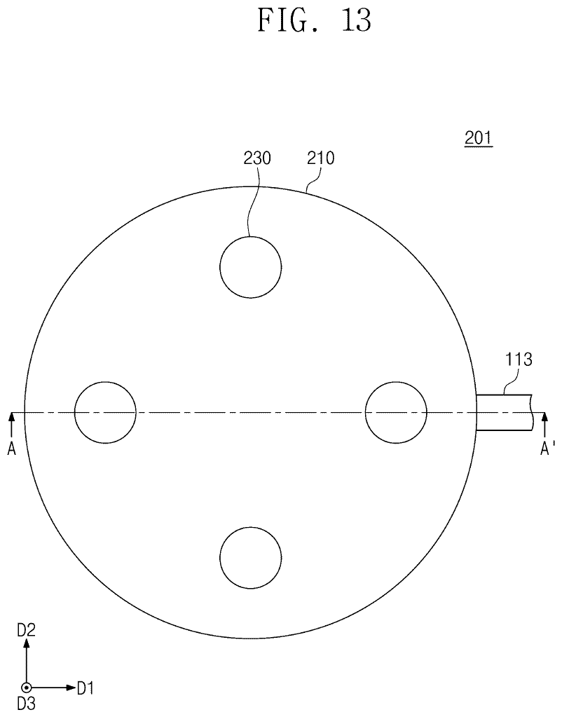

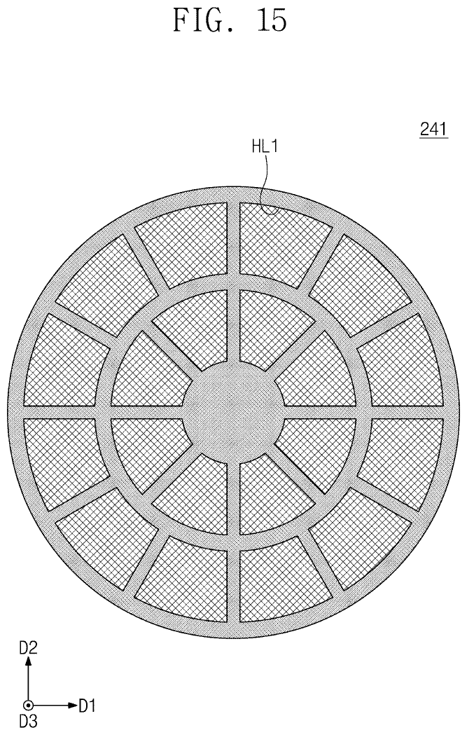

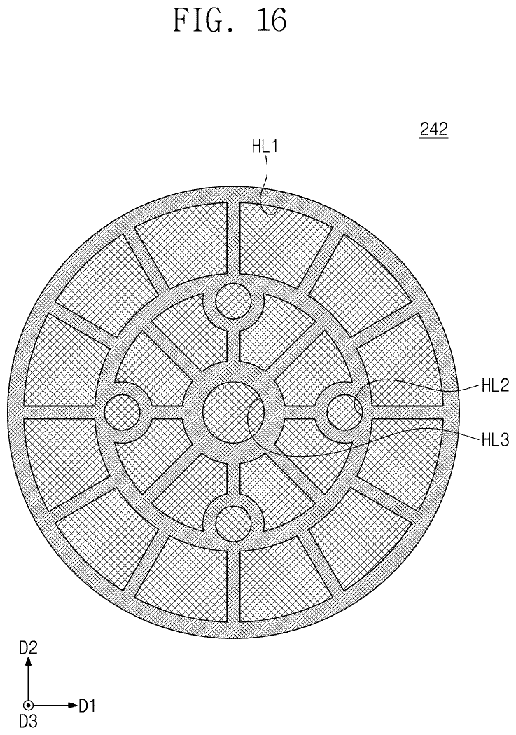

FIG. 13 is a plan view of the first tank of FIG. 1. FIG. 14 is a cross-sectional view taken along line A-A′ of FIG. 13. FIG. 15 is a plan view illustrating a lower fixing device of the first tank of FIG. 13. FIG. 16 is a plan view illustrating an upper fixing device of the first tank of FIG. 13.

Referring to FIGS. 13, 14, 15 and 16, the first tank 201 may include an adsorption housing 210, an injection port 230, a lower fixing device 241 and an upper fixing device 242. Referring to FIGS. 13, 14, 15 and 16, the first tank 201 will be described and also be equally/similarly applied to the second tank 202 described with reference to FIG. 1.

The adsorption housing 210 may have an internal space and may extend in a third direction D3. Adsorbents 220 may be provided inside the adsorption housing 210. The adsorbents 220 may include, but are not limited to, silica gel, activated alumina, and molecular sieves, and also, any material capable of removing moisture contained in a compressed gas may be used.

The lower fixing device 241 may be provided at a lower portion of the adsorption housing 210. The upper fixing device 242 may be provided at an upper portion of the adsorption housing 210. Each of the lower fixing device 241 and the upper fixing device 242 may include first holes HL1 therein. For example, each of the lower fixing device 241 and the upper fixing device 242 may include a configuration such as a perforated plate or mesh within the first holes HL1 to block at least a portion of a space defined by the first holes HL1.

The adsorbents 220 may be disposed between the lower fixing device 241 and the upper fixing device 242. When a bottom surface of the lower fixing device 241 is defined as a first level LV1, and a top surface of the upper fixing device 242 is defined as a second level LV2, the adsorbents 220 may be disposed between the first level LV1 and the second level LV2. When the uppermost end of the adsorption housing 210 is defined as a third level LV3, the adsorbents 220 may not be disposed between the second level LV2 and the third level LV3.

The injection port 230 may pass through the upper fixing device 242. The injection port 230 may be provided within the second hole HL2 of the upper fixing device 242. The adsorbents 220 may be injected into the adsorption housing 210 through the injection port 230. The injection port 230 may be provided in plurality. Particularly, the injection port 230 may be provided in plurality at an outer portion of the adsorption housing 210 rather than being provided in one at the center of the adsorption housing 210 on a plane. Thus, the adsorbents 220 may be evenly injected into the adsorption housing 210.

During the regeneration process for the adsorbents 220 of the first tank 201, a heating gas HA heated by the heater (see 300 in FIG. 1) may be injected into the adsorption housing 210 through the first connection line 113. The regeneration process for the adsorbents 220 of the first tank 201 may mean removing of moisture from the adsorbents 220 through a heating gas HA.

The first connection line 113 may include a first portion 113a extending to the inside of the adsorption housing 210 by passing through a side surface of the adsorption housing 210 and a second portion 113b connected to the first portion 113a to pass through the upper fixing device 242.

The first portion 113a of the first connection line 113 may be disposed at a lower vertical level than the upper fixing device 242. The first portion 113a of the first connection line 113 may be surrounded by the adsorbents 220. One portion of the first portion 113a of the first connection line 113 may extend in a horizontal direction, and the other portion of the first portion 113a of the first connection line 113 may extend in the third direction D3. Thus, the heating gas HA may horizontally proceed through one portion of the first portion 113a of the first connection line 113 and may be injected into the adsorption housing 210 in the third direction D3 through the other portion of the first portion 113a of the first connection line 113.

The second portion 113b of the first connection line 113 may be provided within a third hole HL3 of the upper fixing device 242. For example, the third hole HL3 of the upper fixing device 242 may be defined at a center of the upper fixing device 242. For example, the uppermost end of the second portion 113b of the first connection line 113 may be disposed at a higher vertical level than the adsorbents 220. For example, the second portion 113b of the first connection line 113 may be provided as a perforated plate, and thus, the heating gas HA may pass through holes of the perforated plate and then be injected into the adsorption housing 210.

The regeneration process for the adsorbents 220 may be performed by injecting the heating gas HA into the adsorption housing 210 through the first connection line 113 and passing through a space inside the adsorption housing 210 between the first level LV1 and the second level LV2. The heating gas HA may pass through the space inside the adsorption housing 210 between the first level LV1 and the second level LV2 and then be discharged through the first line 111.

According to embodiments of the disclosed concepts, the heating gas HA injected from the first connection line 113 may be injected into the adsorption housing 210 in the third direction D3. Thus, the heating gas HA may collide with the uppermost end of the adsorption housing 210 and be evenly spread into the space inside the adsorption housing 210 between the second level LV2 and the third level LV3. In addition, the heating gas HA may be evenly spread within the space inside the adsorption housing 210 between the first level LV1 and the second level LV2. As a result, efficiency of the regeneration process for the adsorbents 220 may be improved, and a progress time taken to perform the regeneration process for the adsorbents 220 may be reduced. Thus, the power consumption of the air dryer (see 10 in FIG. 1) may be reduced.

In addition, the adsorbents 220 may not be provided between the second level LV2 and the third level LV3. The adsorbents 220 may be provided between the second level LV2 and the third level LV3, and thus, when surrounding the second portion 112b of the first connection line 113, the adsorbents 220 surrounding the second portion 112b of the first connection line 113 may interrupt the heating gas HA from being evenly spread inside the adsorption housing 210. In this case, the efficiency of the regeneration process for the adsorbents 220 may be deteriorated, and the progress time taken to perform the regeneration process for the adsorbents 220 may increase. The present disclosure may solve the above limitation because the adsorbents 220 are not provided between the second level LV2 and the third level LV3. Thus, the power consumption of the air dryer (see 10 in FIG. 1) may be reduced.

According to the disclosed concepts, the flow guide may be disposed in the region adjacent to the baffle provided within the guide region. Thus, the heat stagnation regions may not be formed or may be formed less frequently within the housing of the heater. As a result, the heat transfer may be sufficiently achieved to the outlet portion of the housing of the heater. Therefore, the temperature at the outlet portion of the housing of the heater may increase.

Additionally, the outer diameter of the flow guide may be larger than the outer diameter of the baffle. Thus, the flow guide may restrict the progression of the heater airflow passing between the baffle and the inner wall of the housing of the heater. As a result, the heat transfer time taken to transfer the heat to the heater airflow through the heating wire may increase. Therefore, as the temperature of the heater airflow increases, the temperature at the outlet portion of the housing of the heater may increase.

As described above, as the temperature of the outlet portion of the housing of the heater increases, the power consumption of the heater consumed for adjusting the temperature of the outlet portion of the housing to the target temperature may be reduced. Therefore, the power consumption of the air dryer may be reduced.

In addition, the adsorbents may be provided between the lower fixing device and the upper fixing device within the adsorption housing of the tank and may not be provided between the upper fixing device and the uppermost end of the adsorption housing. The portion of the connection line may pass through the side surface of the adsorption housing to extend to the inside of the housing. The other portion of the connection line may extend to the inside of the housing to pass through the upper fixing device. Therefore, the heater gas may be injected vertically into the adsorption housing and may be evenly spread within the adsorption housing by colliding with the uppermost end of the adsorption housing without the interference from the adsorbents. As a result, the efficiency of the regeneration process for the adsorbents may be improved. Therefore, the progress time of the regeneration process for the adsorbents may be reduced, and the power consumption of the air dryer may be reduced.

The above-described descriptions according to the embodiments of the disclosed concepts are provided as examples for explaining the disclosed concepts. Thus, it is understood that the present invention should not be limited to these exemplary embodiments but various changes and modifications can be made by one ordinary skilled in the art within the spirit and scope of the present invention as hereinafter claimed.

What is claimed is:

1. An air dryer comprising:
a first tank; and
a heater connected to the first tank,
wherein the heater comprises:
a housing extending in a first direction and having an internal space comprising a first guide region and a second guide region, which are spaced apart from one another in the first direction;
a first baffle provided in the first guide region;
a second baffle provided in the second guide region; and
a first flow guide between the first guide region and the second guide region,
wherein each of the first and second guide regions comprises a first region and a second region,
a portion of the second region of the first guide region is adjacent to the first region of the second guide region in the first direction, and
the first flow guide is adjacent to the second region of the first guide region in the first direction.

2. The air dryer of claim 1, wherein, in the first direction, a distance between the first flow guide and the first guide region is less than a distance between the first flow guide and the second guide region.

3. The air dryer of claim 1, wherein the second region of each of the first guide region and second guide region comprises a first flow region,
wherein the first flow region of the first guide region is configured to surround the first region of the first guide region, and
the first region of the second guide region is configured to surround the first flow region of the second guide region.

4. The air dryer of claim 3, wherein each of the first and second baffles comprises a plurality of holes,
wherein the holes of the first baffle is provided in the first flow region of the first guide region, and
the holes of the second baffle is provided in the first flow region of the second guide region.

5. The air dryer of claim 4, wherein the first flow guide is adjacent to a portion of the holes of the first baffle in the first direction.

6. The air dryer of claim 3, further comprising:
a third guide region disposed to be spaced apart from the first guide region in the first direction with the second guide region between the first guide region and the third guide region; and
a second flow guide between the second guide region and the third guide region,
wherein an outer diameter of the second flow guide is greater than an outer diameter of the second baffle.

7. The air dryer of claim 6, wherein, in the first direction, a distance between the second flow guide and the second guide region is less than a distance between the second flow guide and the third guide region.

8. The air dryer of claim 6, further comprising:
a third baffle provided in the third guide region; and
a third flow guide disposed to be spaced apart from the second flow guide in the first direction with the third guide region between the third guide region between the second flow guide and the third flow guide,
wherein an outer diameter of the third flow guide is greater than an outer diameter of the third baffle.

9. The air dryer of claim 1, wherein an inner diameter of the first flow guide is greater than an outer diameter of the first region of the first guide region.

10. The air dryer of claim 1, wherein the first region of the first guide region is not adjacent to the first region of the second guide region in the first direction.

11. The air dryer of claim 1, wherein the first flow guide has a shape of a circular ring or a semicircular ring.

12. The air dryer of claim 1, wherein an outer diameter of the first flow guide is greater than an outer diameter of the first baffle.

13. The air dryer of claim 1, wherein, in a second direction orthogonal to the first direction, a width of the first region of the first guide region is greater than a width of the first flow guide.

14. An air dryer comprising:
a first tank;
a connection line on a side surface of the first tank; and
a heater configured to provide a heating gas to the first tank through the connection line,
wherein the first tank comprises:
an adsorption housing filled with adsorbents; and
a lower fixing device and an upper fixing device within the adsorption housing,
wherein the adsorbents are interposed between the lower fixing device and the upper fixing device, and
the connection line comprises:
a first portion extending to the inside of the adsorption housing by passing through a side surface of the adsorption housing; and
a second portion connected to the first portion to pass through the upper fixing device.

15. The air dryer of claim 14, wherein the first portion of the connection line is disposed at a lower vertical level than the upper fixing device.

16. The air dryer of claim 14, wherein the first portion of the connection line is surrounded by the adsorbents.

17. The air dryer of claim 14, wherein the uppermost end of the second portion of the connection line is disposed at a higher vertical level than the adsorbents.

18. The air dryer of claim 14, wherein:
one portion of the first portion of the connection line extends in a horizontal direction, and
another portion of the first portion of the connection line extends in a vertical direction.

19. The air dryer of claim 18, wherein the other portion of the first portion of the connection line is interposed between the one portion of the first portion of the connection line and the second portion of the connection line.

20. An air dryer comprising:
a first tank filled with adsorbents;
a connection line connected to the first tank; and
a heater configured to a heating gas to the first tank through the connection line
wherein the heater comprises:
a housing extending in a first direction and having an internal space comprising a first guide region and a second guide region, which are spaced apart from one another in the first direction;
a first baffle provided in the first guide region;
a second baffle provided in the second guide region; and
a first flow guide between the first guide region and the second guide region,
wherein each of the first and second guide regions comprises a first region and a second region,
a portion of the second region of the first guide region is adjacent to the first region of the second guide region in the first direction, and
the first flow guide is adjacent to the second region of the first guide region in the first direction.
